(19) United States
(12) Patent Application Publication
(10) Pub. No.: US 2010/0001857 A1
(43) Pub. Date: Jan. 7, 2010

(54) SITUATION RECOGNIZING APPARATUS, SITUATION RECOGNIZING METHOD, AND RADIO TERMINAL APPARATUS

(75) Inventors: Miwako DOI, Kawasaki-shi (JP); Toshiro Hiraoka, Yokohama-shi (JP); Hiroki Inagaki, Kawasaki-shi (JP); Kazushige Ouchi, Saitama-shi (JP); Noriaki Oodachi, Kawasaki-shi (JP); Tatsuyuki Matsushita, Tokyo (JP); Akihisa Moriya, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/427,880

(22) Filed: Apr. 22, 2009

(30) Foreign Application Priority Data
Jul. 1, 2008 (JP) 2008-172193

(51) Int. Cl. G08B 1/08

(52) U.S. Cl. 340/539.13; 340/539.1

(57) ABSTRACT

A situation recognizing apparatus has a situation change detecting unit, being provided with situation information, configured to detect a situation change on the basis of the situation information, a first storage which stores the detected situation change, an input unit which is provided with a user operation, and a second storage which combines the user operation provided to the input unit with the situation change stored in the first storage and stores the combined user operation and the situation change as a unique pattern.

### CROSS REFERENCE TO RELATED APPLICATIONS

This application is based upon and claims the benefit of priority from the Japanese Patent Application No. 2008-172193, filed on Jul. 1, 2008, the entire contents of which are incorporated herein by reference.

### BACKGROUND OF THE INVENTION

1. Field of the Invention

The present invention relates to a situation recognizing apparatus, a situation recognizing method, and a radio terminal apparatus.

2. Related Art

The so-called recommendation services are being provided that recommend items based on a history of items purchased by users on the Internet to the users who purchased items similar to those items. Broadcast program recommendation services are also being provided that learn users' preferences on the basis of the users' television program viewing histories or program recording histories and recommend television programs on the basis of the users' preferences.

These services use meta data such as the types of contents or such as items purchased by users or programs viewed or recorded by viewers or the so-called electronic television guides added to contents. That is, information used for learning preferences is symbols, namely text information.

On the other hand, many research studies have been conducted on recommendation based on data mining of action histories. Action histories represented by time-series signal information such as acceleration sensor information or time-series symbol information such as location information is converted into symbol strings and learned to make recommendations.

In conventional data mining approaches, time-series data such as acceleration sensor data is first divided into analysis segments in a range from 1 to 30 seconds and multiple feature quantities in each of the analysis segments, such as the average, maximum value, and minimum value are detected. Then, the future quantities and time-series information that is separately obtained are used to identify actions such as walking and running by a method such as a clustering, neural network, or binary classification tree method (for example, refer to IP-A 2005-21450(KOKAI)).

In these conventional approaches, actions to be identified such as walking, running, seating, and working are determined beforehand, a combination of appropriate feature quantities that can be classified as these actions and a weighting factor of the combination are detected to create an identification model, and action recognition is performed on the basis of the identification model.

As mobile phones become equipped with location information acquisition functions such as GPS (Global Positioning Service), it has become possible to locate users on some level where they are in outdoor locations. Mobile phones including an electronic money function enable acquisition of location information both in-doors and out-doors by adding information on the locations in which electronic payment was made. Research and development is being performed on recommendation so-called concierge service that uses time-series location information and schedules stored in mobile phones in combination.

However, there is a problem that not all users input detailed schedules. In addition, most of events entered in schedules in business-use mobile phones are indoor events such as meetings at offices. Electronic payment is rarely made at office and therefore it is difficult to obtain precise indoor location information.

In the conventional method in which time-series data is divided into predetermined time units in accordance with the type of action to be identified, feature quantities are extracted from the data to create an identification model by data mining to identify an action, the action to be identified must be defined beforehand.

The conventional method presents no problem as long as very limited actions are to be recognized, such as walking, running, seating, and working. However, real human actions are not limited. In particular, if the result of action recognition based on identification models is to be connected with a service called concierge service that uses mobile terminals such as mobile phones, it is difficult to adapt the action recognition to wide variety of functions of the mobile terminals and new functions developed and added to the mobile terminals.

A method that divides data into analysis segments independently of feature quantities in signal information is tantamount to dividing speech data regardless of words and phonemes uttered, such as “tomorrow”, “plan”, “/t/”, “/o/”, or “/r/”, or presence or absence of utterance. To improve the accuracy of speech recognition, it is essential to extract segments that are distinctive as speech, such as words and phonemes, from speech data. It is required that meaningful segments be extracted in situation recognition as well, like words and phonemes in speech recognition.

### SUMMARY OF THE INVENTION

According to one aspect of the present invention, there is provided a situation recognizing apparatus comprising:

a situation change detecting unit, being provided with situation information, configured to detect a situation change on the basis of the situation information;

a first storage which stores the detected situation change;

an input unit which is provided with a user operation; and

a second storage which combines the user operation provided to the input unit with the situation change stored in the first storage and stores the combined user operation and the situation change as a unique pattern.

According to one aspect of the present invention, there is provided a situation recognizing method comprising:

detecting a situation change on the basis of situation information;

storing the detected situation change in a first storage; and

when a user operation is provided, storing the situation change stored in the first storage in a second storage along with the user operation as a unique pattern.

According to one aspect of the present invention, there is provided a radio terminal apparatus comprising:

an antenna which receives a radio frequency signal and generates a received analog signal;

a receiving unit which amplifies, down-converts, and analog-to-digital converts the received analog signal to generate a digital signal;

a signal processing unit which demodulates the digital signal to generate received data;

a control unit connected to the signal processing unit to control data processing; and

a situation recognizing apparatus, connected to the control unit, including a situation change detecting unit which is provided with situation information and detects a situation change on the basis of the situation information, a first storage which stores the detected situation change, an input unit which is provided with a user operation, and a second storage which combines the user operation provided to the input unit with the situation change stored in the first storage and stores the combined user operation and the situation change as a unique pattern.

### BRIEF DESCRIPTION OF THE DRAWINGS

FIG. 1 is a schematic diagram showing a configuration of a situation recognizing apparatus according to a first embodiment of the present invention;

FIG. 2 is a graph showing an example of variations in acceleration;

FIG. 3 is a graph showing an example of variations in illuminance;

FIG. 4 is a diagram showing an example of acquisition of a unique pattern;

FIG. 5 is a flowchart illustrating a situation recognizing method according to the first embodiment;

FIG. 6 is a diagram showing exemplary unique patterns;

FIG. 7 is a diagram showing exemplary unique patterns;

FIG. 8 is a schematic diagram showing a configuration of a situation recognizing apparatus according to a second embodiment of the present invention;

FIG. 9 is a flowchart illustrating a situation recognizing method according to the second embodiment;

FIG. 10 is a diagram showing an example of foreseeing of a user operation;

FIG. 11 is a schematic diagram showing a configuration of a situation recognizing apparatus according to a variation; and

FIG. 12 is a schematic diagram showing a radio terminal apparatus including a situation recognizing apparatus according to an embodiment of the present invention.

### DESCRIPTION OF THE EMBODIMENTS

Embodiments of the present invention will be described below with reference to the accompanying drawings.

### First Embodiment

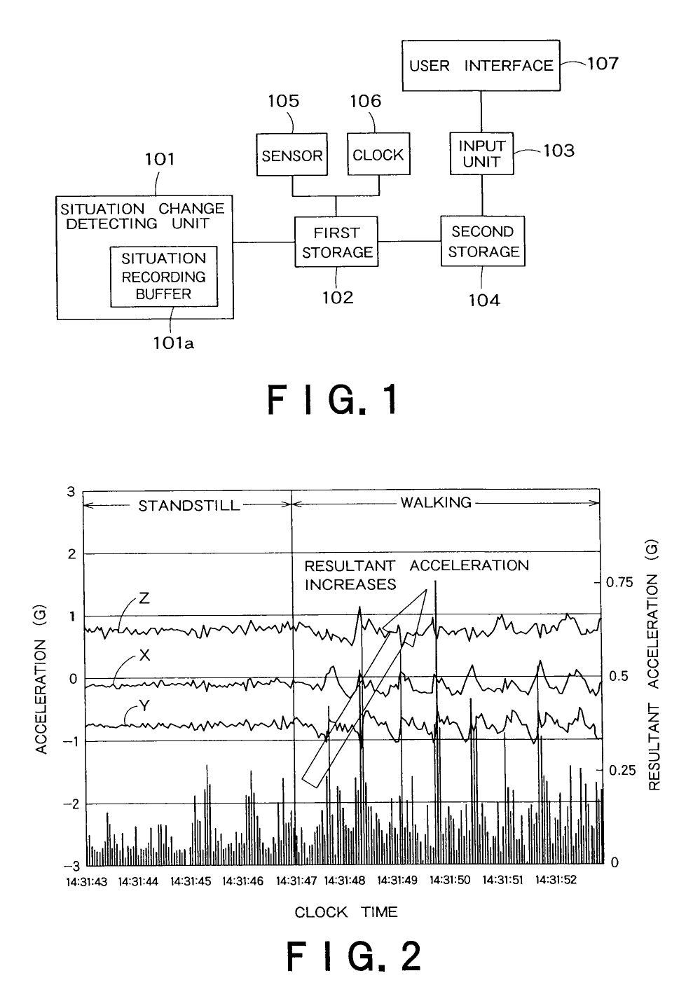

FIG. 1 schematically shows a configuration of a situation recognizing apparatus according to a first embodiment of the present invention. The situation recognizing apparatus includes a situation change detecting unit 101, a first storage 102, an input unit 103, a second storage 104, a sensor 105, a clock 106, and a user interface 107. The situation change detecting unit 101 includes a situation recording buffer 101a.

The situation change detecting unit 101 receives situation information, which is information about a situation, stores the situation information in the situation recording buffer 101a, and detects a situation change by using the situation information. Here, the situation information may be acceleration information output from a acceleration sensor which measures acceleration, illuminance information output from an illuminance sensor which measures brightness, sound information output from a microphone which measures sound, temperature information output from a temperature sensor which measures temperature, azimuth information output from an electronic compass which measures azimuth, atmospheric pressure information output from an atmospheric pressure sensor which measures atmospheric pressure, ambient gas information output from a humidity sensor which senses humidity or a gas sensor which senses a gas such as carbon dioxide gas, or biological information output from a biological sensor, for example. The operating status of a CPU, a remaining battery level, radio signal reception conditions, and incoming calls can also be used as situation information.

Acceleration information is suited for use as situation information because acceleration is often directly relative to actions of users. Illuminance information and sound information often reflect the situations surrounding users and therefore suitable for use as situation information.

For example, the situation change detecting unit 101 is provided with acceleration information including information on accelerations Xn, Yn, and Zn in the x-, y-, and z-axis directions (horizontal and vertical directions) as shown in FIG. 2 from an acceleration sensor and calculates the resultant acceleration Acc. The equation used for calculating the resultant acceleration Acc is given below.

Acc=\sqrt{(Xₙ−Xₙ₋₁)²+(Yₙ−Yₙ₋₁)²+(Zₙ−Zₙ₋₁)²}

The resultant acceleration Acc is represented by the vertical axis in FIG. 2.

The situation change detecting unit 101 determines situations from changes in the resultant acceleration at intervals of one second, for example. In the example shown in FIG. 2, the resultant acceleration increased after 14:31:47, and therefore a situation change from standstill to walking (behavior change) is detected.

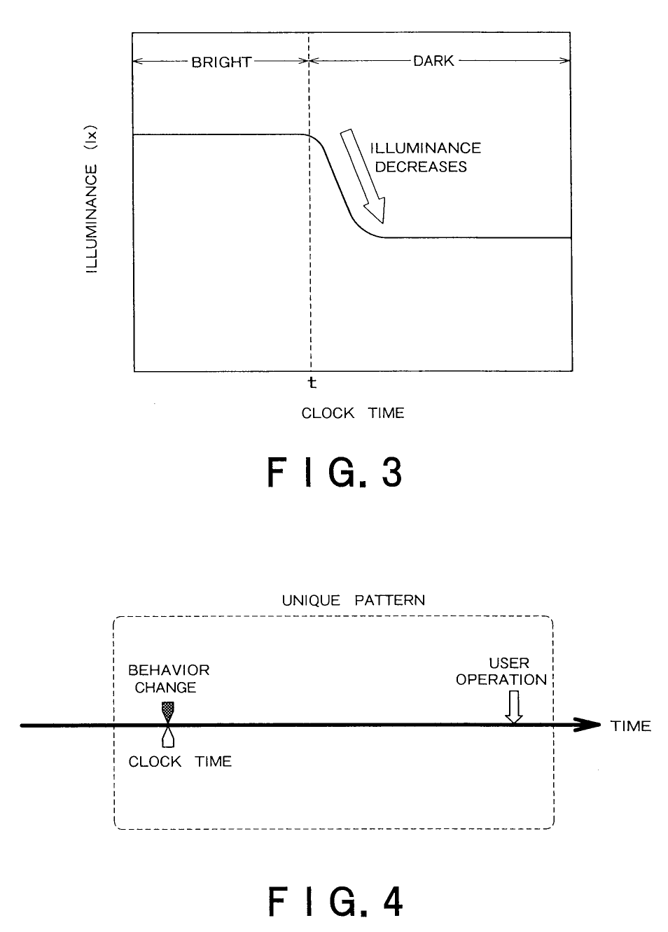

The situation change detecting unit 101 may detect a situation change from illuminance information as shown in FIG. 3 which is output from an illuminance sensor. In the example shown in FIG. 3, the illuminance decreased after time point t and a situation change (illuminance change) from a bright situation to a dark situation is detected. A situation change detected from such illuminance information may occur when the user goes out of a bright room to a dark hallway or the user turns off the lighting of the room.

The method for detecting a situation change from situation information is not limited to a specific one. For example, exceeding a predetermined threshold may be considered to be a situation change.

The various sensors that provide information to the situation change detecting unit 101 may be one of components of the situation change detecting unit 101 or may be installed outside the situation change detecting unit 101.

When the situation change detecting unit 101 detects a situation change, the situation change detecting unit 101 stores the situations before and after the change in the first storage 102. Here, information from the sensor 105 and time information from the clock 106 may be recorded along with the information. The sensor 105 may be a GPS sensor which obtains location information using radio waves from satellites or a location sensor such as a positioning system which obtains location information from wireless LAN access points.

When a user operation is input in the input unit 103 through the user interface 107, the input is stored in the second storage 104 as a unique pattern along with the situation change and/or sensor information stored in the first storage 102. The user interface 107 includes an input device and, if required, an output device and an information processing device and may include devices such as a display, a keypad, and touch panel.

For example, a unique pattern, as shown in FIG. 4, containing a situation change (behavior change) and sensor information including the time at which the situation change has occurred are stored in the second storage 104.

When the unique pattern is stored in the second storage 104, the situation change and sensor information stored in the first storage 102 are deleted.

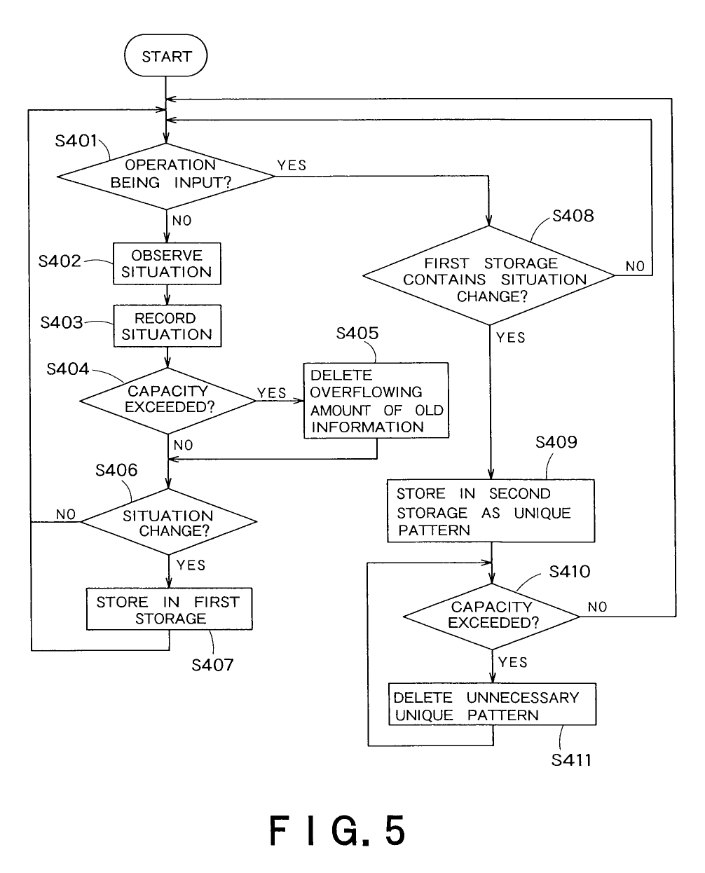

A method for obtaining such a unique pattern using the situation recognizing apparatus will be described with reference to the flowchart shown in FIG. 5.

(Step S401) Determination is made as to whether a user operation is being input in the input unit 103 through the user interface 107. If so, the process proceeds to step S408; otherwise, the process proceeds to step S402.

(Step S402) Information on the situation observed by various sensors such as an acceleration sensor (situation information) is obtained.

(Step S403) The situation information obtained is stored in the situation recording buffer 101a.

(Step S404) Determination is made as to whether the capacity of the situation recording buffer 101a will be exceeded. If so, the process proceeds to step S405; otherwise the process proceeds to step S406.

(Step S405) Old information among the situation information stored in the situation recording buffer 101a that has the size equivalent to the overflowing amount is deleted from the situation recording buffer 101a.

(Step S406) Determination is made on the basis of the situation information stored in the situation recording buffer 101a as to whether the situation (behavior) has changed. If changed, the process proceeds to step S407; otherwise, the process returns to step S401.

(Step S407) The situations before and after the change (behaviors) are stored in the first storage 102. At this time, the information from the sensor 105 and time information from the clock 106 are also recorded as needed.

(Step S408) Determination is made as to whether a status change is stored in the first storage 102. If stored, the process proceeds to step S409; otherwise, the process returns to step S401.

(Step S409) The user operation input is stored in the second storage 104 as a unique pattern together with the status change stored in the first storage 102.

(Step S410) Determination is made as to whether the capacity of the second storage 104 will be exceeded. If so, the process proceeds to step S411; otherwise, the process returns to step S401.

(Step S411) A unique pattern among the unique patterns stored in the second storage 104 that is no longer necessary and has the size equivalent to the overflowing amount is deleted from the second storage 104. Unnecessary unique pattern is an old unique pattern, for example.

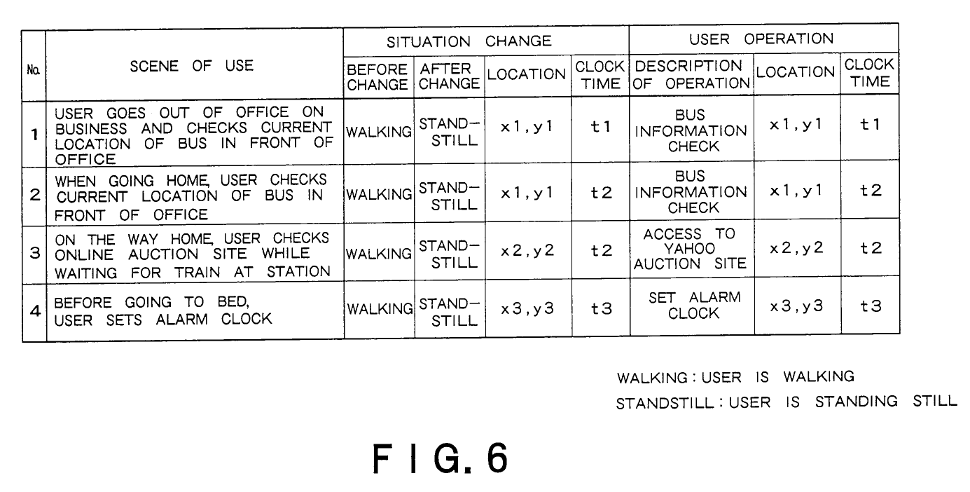

An example of a unique pattern obtained by the method described above is shown in FIG. 6. For example, in the scene “The user goes out of the office on business and checks the current location of a bus in front of the office”, the user walks to go out of the office and stops in front of the office in order to check information about the bus. At this point, a situation (behavior) change occurs from walking to standstill. Together with the situation change, location information (x1, y1) obtained from a GPS as the sensor 105, and situation change clock time t1 obtained from the clock 106 are stored in the first storage 102.

Then, a user operation of checking bus information is input in the input unit 103 through the user interface 107. The user operation is stored in the second storage 104 as a unique pattern together with one situation change stored in the first storage 102.

Other unique patterns are similarly stored in the second storage 104.

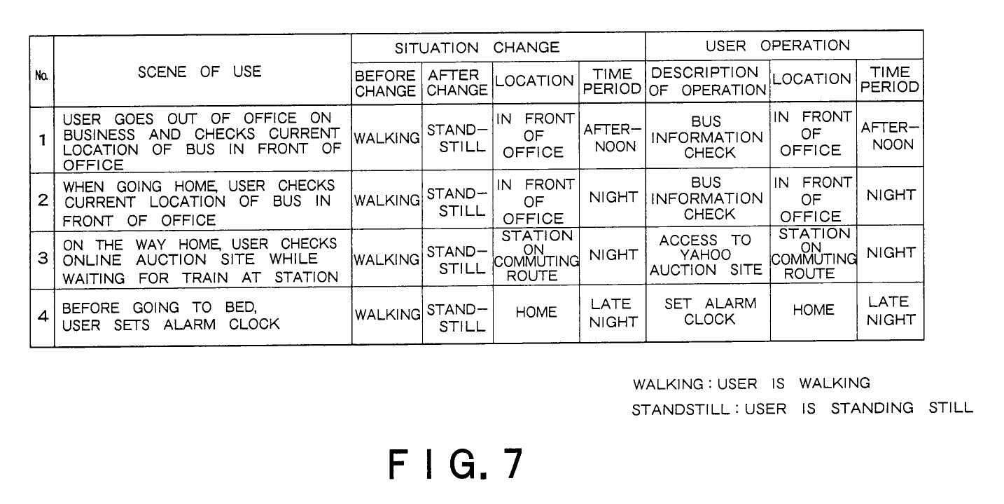

The information stored is not limited to that shown in FIG. 6. For example, the location information obtained through GPS may be converted to a place name or street address as shown in FIG. 7 by reverse geocoding. Clock time may be classified as a time period such as morning, afternoon, evening, night, or late-night and the time period may be stored.

In this way, when the situation recognizing apparatus according to the present embodiment detects a situation change, the situation recognizing apparatus stores the situation change (situations before and after the change) and various sensor information in the first storage 102. When subsequently a user operation is input, the situation recognizing apparatus combines one situation change stored in the first storage 102 and the user operation into a unique pattern and stores the unique pattern in the second storage 104.

The unique pattern including the user operation and the situation change associated with the user operation is obtained as a unit for recognition processing. Therefore, actions (user operations) to be recognized do not need to be defined beforehand and actions that are not defined can be recognized by extracting segments of time-series data that are suitable for use for identifying individual user actions.

Furthermore, since data unnecessary for action identification is not stored, the data amount stored in the storage (the second storage 104) can be reduced.

### Second Embodiment

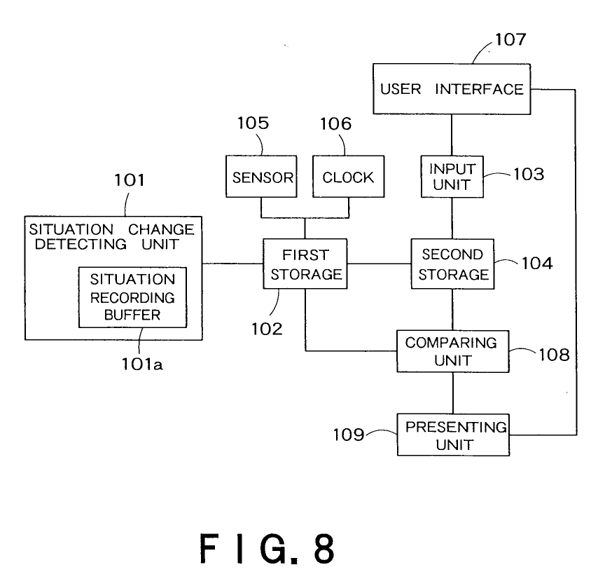

FIG. 8 schematically shows a configuration of a situation recognizing apparatus according to a second embodiment of the present invention. The same components as those of the situation recognizing apparatus according to the first embodiment shown in FIG. 1 are labeled with the same reference numerals and description of which will be omitted. The situation recognizing apparatus according to the second embodiment includes a comparing unit 108 and a presenting unit 109 in addition to those components.

The comparing unit 108 compares a situation change stored in a first storage 102 with a situation change portion (the portion other than a user operation) of each unique pattern stored in a second storage 104 and extracts a matching unique pattern. The matching unique pattern may be a unique pattern containing a situation change portion (including the situations before and after the change and sensor information) that matches or resembles the situation change stored in the first storage 102.

The presenting unit 109 presents a user operation, an operation equivalent to a user operation, or an operation assisting a user operation contained in a unique pattern extracted by the comparing unit 108 to the user interface 107. An operation assisting a user operation may be an operation for displaying a user operation menu. For example, the operation may be an operation for displaying a relevant user operation menu (list) on the display for assisting a user operation for selecting various applications such as an electronic mail application or a Web browser or various services such as a bus information.

That is, the comparing unit 108 “foresees” an operation that the user may perform in the future on the basis of comparison between the situation change stored in the first storage 102 and the situation change portion of the unique pattern stored in the second storage 104. The presenting unit 109 presents an operation menu required for performing the user operation before the user actually performs the user operation.

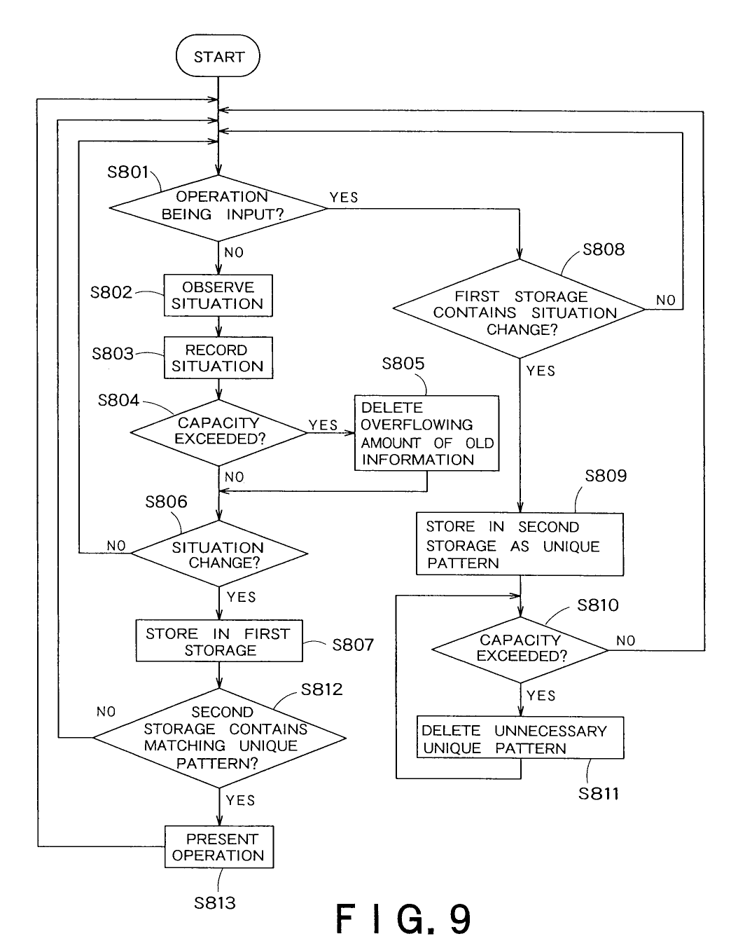

Such a method for foreseeing a user operation using the situation recognizing apparatus will be described with reference to the flowchart shown in FIG. 9. Steps S801 through S811 are the same as steps S401 through S411 of the flowchart shown in FIG. 4 in the first embodiment and therefore description of which will be omitted. While the process in the first embodiment returns to step S401 after a situation change is stored in the first storage 102 at step S407, the process in the second embodiment proceeds to step S812 after a situation change is stored in the first storage 102 at step S807.

(Step S812) A situation change pattern stored in the first storage 102 is compared with the situation change portion of each unique pattern stored in the second storage 104 to detect whether there is a matching (identical or similar) pattern. If there is a matching pattern, the process proceeds to step S813; otherwise, the process returns to step S801.

(Step S813) The user operation contained in the unique pattern detected at step 812 or an operation menu required for the operation is presented.

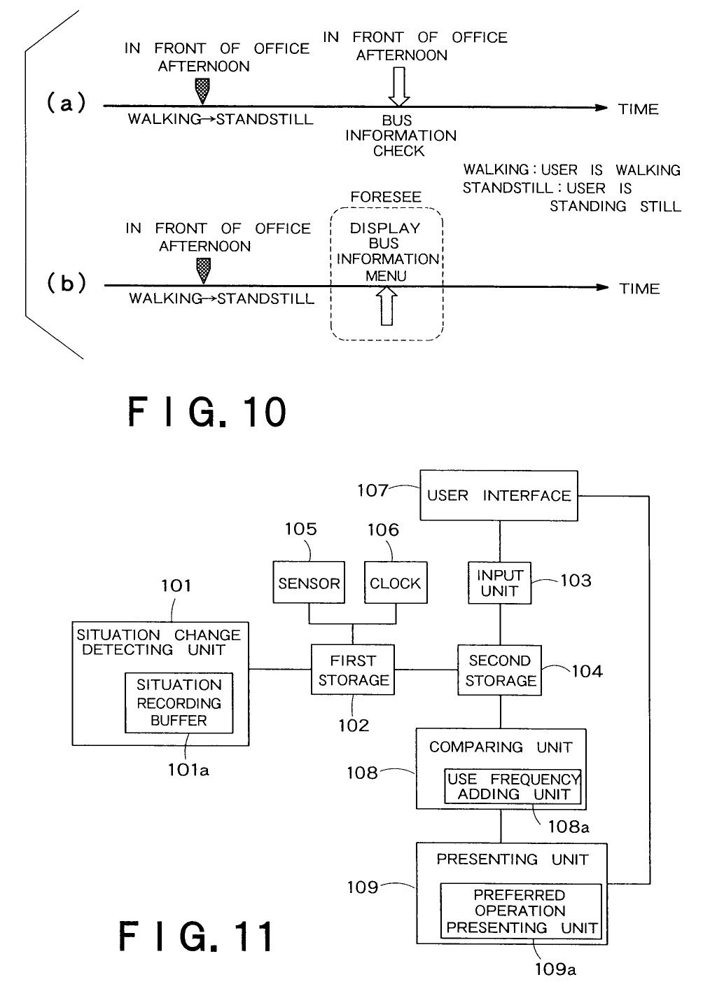

For example, when a unique pattern including a location, “in front of office”, a time period, “afternoon”, a situation change, “from walking to standstill”, and a user operation, “bus information check”, as shown in FIG. 10(a) is stored in the second storage 104 and a situation change as shown in FIG. 10(b) is stored in the first storage 102, the comparing unit 108 extracts the unique pattern. The presenting unit 109 refers to the user operation included in the unique pattern to foresee the operation that the user may perform and presents a bus information menu.

In this way, the situation recognizing apparatus according to the present embodiment can obtain a unique pattern including a user operation and a situation change associated with the user operation as a unit for recognition processing and recognize an action that is not predefined. Furthermore, since a segment of time-series data that is suitable for use for identifying an action is extracted and data that weakly correlates with user operations and are unnecessary for action identification is not stored, the memory capacity of the storage (the second storage 104) can be saved.

In addition, the situation recognizing apparatus can efficiently foresee the user operation with a high accuracy by detecting the type of a situation change such as a change from waking to standstill and comparing the situation change with unique patterns obtained beforehand.

The comparing unit 108 of the situation recognizing apparatus according to the present embodiment may further include a use frequency adding unit 108a as shown in FIG. 11 that obtains the frequency of use (the frequency of extraction) of a unique pattern on the basis of the result of comparison between a situation change pattern stored in the first storage 102 and the situation change portion of a unique pattern stored in the second storage 104.

Unique patterns that have been infrequently used may be deleted as unnecessary unique patterns at step S811.

A preferred operation presenting unit 109a that preferentially presents a user operation contained in a unique pattern with a high use frequency may be provided as shown in FIG. 11. This is suitable for a case where there are unique patterns containing the same situation change portion and different user operations.

In the embodiments described above, when a user operation is provided, the user operation and the situation change stored in the first storage 102 are combined together and stored in the second storage 104 as a unique pattern. However, a situation change that occurred significantly earlier than a user operation and correlates weakly with the user operation can be stored in the first storage 102. Therefore, if the time at which the situation change stored in the first storage 102 occurred is earlier by a predetermined time than the time at which a user operation occurred, generation of a unique pattern may be prevented.

Furthermore, if a user operation is not performed within a predetermined time period from the time at which the situation change stored in the first storage 102 occurred, the situation change may be deleted from the first storage 102.

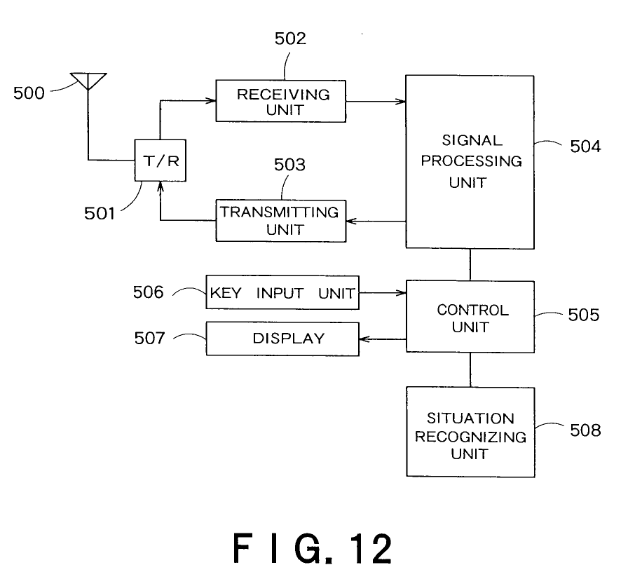

The situation recognizing apparatus described above can be applied to a radio terminal apparatus such as a mobile phone. FIG. 12 shows an exemplary configuration of a radio terminal apparatus including the situation recognizing apparatus. A radio frequency (RF) signal is received at an antenna 500 and the received analog signal is input in a receiving unit 502 through a duplexer 501.

The receiving unit 502 performs processing such as amplification, frequency conversion (down-conversion), and analog-to-digital conversion to the received signal to generate a digital signal. The digital signal is provided to a signal processing unit 504, where processing such as demodulation is performed to generate received data.

In transmission, on the other hand, a signal provided from the signal processing unit 504 is subjected to digital-to-analog conversion and frequency conversion (up-conversion) to be converted to an RF signal and the RF signal is amplified in the transmitting unit 503, then the amplified signal is provided to an antenna 500 through the duplexer 501 and is transmitted as a radio wave.

A control unit 505 controls data processing. A key input unit 506, a display 507, and a situation recognizing unit 508 are connected to the control unit 505. The situation recognizing unit 508 is equivalent to the situation recognizing apparatus according to any of the embodiments described above. The key input unit 506 and the display 507 are equivalent to the user interface 107 of any of the situation recognizing apparatus according to the embodiments described above.

With the configuration described above, the situation recognizing apparatus according to any of the embodiments described above can be applied to a radio terminal apparatus. The situation recognizing unit 508 is capable of obtaining a unique pattern that is most appropriate for the user of the radio terminal apparatus and foreseeing an operation.

What is claimed is:

1. A situation recognizing apparatus comprising:
a situation change detecting unit, being provided with situation information, configured to detect a situation change on the basis of the situation information;
a first storage which stores the detected situation change;
an input unit which is provided with a user operation; and
a second storage which combines the user operation provided to the input unit with the situation change stored in the first storage and stores the combined user operation and the situation change as a unique pattern.

2. The apparatus according to claim 1, wherein the unique pattern is a combination of the user operation and the one situation change.

3. The apparatus according to claim 1, wherein the situation change detecting unit comprises a situation recording buffer which stores the situation information.

4. The apparatus according to claim 1, further comprising an acceleration sensor which measures acceleration of the apparatus to generate acceleration information and outputs the acceleration information as the situation information, wherein the situation change detecting unit detects a situation change on the basis of variations in the acceleration.

5. The apparatus according to claim 1, further comprising a location sensor which detects a location and outputs location information, wherein the first storage stores location information output from the location sensor along with the situation change.

6. The apparatus according to claim 1, further comprising a clocking unit which measures time and outputs time information, wherein the first storage stores the time information output from the clocking unit along with the situation change.

7. The apparatus according to claim 1, wherein the situation change is deleted from the first storage when the situation change is stored in the second storage as the unique pattern.

8. The apparatus according to claim 1, further comprising:
a comparing unit which compares the situation change stored in the first storage with a situation change portion contained in the unique pattern stored in the second storage to extract a matching unique pattern; and
a presenting unit which presents the user operation contained in the unique pattern extracted by the comparing unit or an operation assisting the user operation.

9. The apparatus according to claim 8, further comprising a use frequency adding unit which detects, on the basis of the result of comparison by the comparing unit, the frequency with which the unique pattern stored in the second storage is extracted and stores the frequency in the second storage.

10. The apparatus according to claim 9, further comprising a preferred operation presenting unit which preferentially presents the user operation contained in a unique pattern used with a high frequency when the comparing unit has extracted a plurality of unique patterns.

11. The apparatus according to claim 9, wherein the second storage deletes a unique pattern with the lowest use frequency when the upper limit of the storage capacity of the second storage is reached.

12. A situation recognizing method comprising:
detecting a situation change on the basis of situation information;
storing the detected situation change in a first storage; and
when a user operation is provided, storing the situation change stored in the first storage in a second storage along with the user operation as a unique pattern.

13. The method according to claim 12, wherein the situation change stored in the second storage as the unique pattern is one situation change.

14. The method according to claim 12, wherein acceleration is measured to generate acceleration information as the situation information and the situation change is detected on the basis of variations in the acceleration.

15. The method according to claim 12, wherein a location is detected to generate location information and the location information is stored in the first storage along with the situation change.

16. The method according to claim 12, wherein time is measured to generate time information and the time information is stored in the first storage along with the situation change.

17. The method according to claim 12, comprising:
comparing a situation change stored in the first storage with a situation change portion of a unique pattern stored in the second storage to extract a matching unique pattern; and
presenting a user operation contained in the extracted unique pattern.

18. The method according to claim 17, wherein the frequency with which the unique pattern stored in the second storage is extracted is detected on the basis of the result of the comparison and the frequency is stored in the second storage.

19. The method according to claim 18, wherein when a plurality of unique patterns are extracted by the comparison, the user operation contained in a unique pattern with a high use frequency is preferentially presented.

20. A radio terminal apparatus comprising:
an antenna which receives a radio frequency signal and generates a received analog signal;
a receiving unit which amplifies, down-converts, and analog-to-digital converts the received analog signal to generate a digital signal;
a signal processing unit which demodulates the digital signal to generate received data;
a control unit connected to the signal processing unit to control data processing; and
a situation recognizing apparatus, connected to the control unit, including a situation change detecting unit which is provided with situation information and detects a situation change on the basis of the situation information, a first storage which stores the detected situation change, an input unit which is provided with a user operation, and a second storage which combines the user operation provided to the input unit with the situation change stored in the first storage and stores the combined user operation and the situation change as a unique pattern.
